(19) United States
(12) Patent Application Publication
(10) Pub. No.: US 2018/0310137 A1
(43) Pub. Date: Oct. 25, 2018

(54) MULTICASTING DATA IN A WIRELESS COMMUNICATIONS NETWORK

(71) Applicant: Samsung Electronics Co., Ltd., Gyeonggi-do (KR)

(72) Inventors: Belkacem MOUHOUCHE, Middlesex (GB); Maziar NEKOVEE, Middlesex (GB)

(21) Appl. No.: 15/767,046

(22) PCT Filed: Oct. 7, 2016
(86) PCT No.: PCT/KR2016/011241

§ 371 Date: Apr. 9, 2018

(30) Foreign Application Priority Data
Oct. 9, 2015 (GB) 1517903.9

(51) Int. Cl. H04W 4/06; H04B 7/06; H04W 4/021; H04W 16/28

(52) U.S. Cl. CPC H04W 4/06; H04B 7/0617; H04B 7/0632; H04W 16/28; H04W 4/021

(57) ABSTRACT

The present disclosure relates to a pre-5th-Generation (5G) or 5G communication system to be provided for supporting higher data rates Beyond 4th-Generation (4G) communication system such as Long Term Evolution (LTE). The present invention provides a method of multicasting data in a wireless communications network.

### TECHNICAL FIELD

The present invention relates to multicasting data in a wireless communications network.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

Interest in 5G based systems and relevant standards have been grown significantly in recent years. Millimetre waves are being considered as a means to carry high throughput content in 5G systems. One of the drawbacks of using millimetre wave systems is the high attenuation at these frequencies. However, developments in advanced antenna arrays and beam control algorithms have provided very efficient beam forming techniques. Beam forming can compensate for the high attenuation in millimetre wave propagation. Recent studies have also shown that millimetre waves can be used for very high throughput delivery in the case of unicast (one to one transmission). Even though many techniques have been proposed for beam forming in 5G for unicast applications, the amount of research in the field of 5G multicasting is comparatively low.

Recently there has been a call from industry to look into the possibilities of expanding the 5G concepts to multicast/broadcast systems. This will enable fast and reliable content delivery for end users. The primary issue in implementing 5G multicasting is that known systems focus on narrow beam based approaches, which will not be reliable on a multicast environment. This is because a narrow beam will not reach a group of users spread over a wide geographical area because normally the coverage area captured by a pencil beam antenna is very small.

### DISCLOSURE OF INVENTION

### Technical Problem

In a unicast situation, content data is intended for one recipient and received by that single recipient. In a multicast/broadcast situation, the same content is intended for more than one recipient and received by multiple recipients. Conventional delivery schemes employ a time frame based distribution of contents. However, the selection of time frame is crucial in this task.

### Solution to Problem

Embodiments of the present invention aim to address at least one of the above problems. Embodiments can provide an optimal scheduling strategy to deliver multicast/broadcast content using millimetre waves. Embodiments can find the best angle that will provide the highest reception rate on average, thus leading to the minimum total multicast time. Embodiments of the multicasting system can analyse the number of users covered by each potential beam angle and the maximum Modulation and Coding Scheme (MODCOD) that would allow the signal to be received by all of them. This can be done in a way that can be considered optimal by having access to information regarding the locations of the receivers and calculating the best combination of bit rate and the number of receivers covered. It can also be done in a sub-optimal way, wherein a base station can use information regarding the distribution of users/receivers in order to decide on the combination of beam forming/MODCOD. The suboptimal method can work better in the case of high number of users. The calculated SNRs can be replaced by the exact Channel Quality Indicator (CQI) fed back by the users.

According to a first aspect of the present invention there is provided a method of multicasting data in a wireless communications network comprising:

obtaining receiver location data relating to locations of a plurality of receivers within an area covered by a transmitter of the wireless communications network;

generating a set of calculated beams, each of the calculated beams having an initial angle and a corresponding beam width;

computing a number of the receivers that would receive data transmitted using each of the calculated beams using the receiver location data;

selecting one of the calculated beams based on the computed number of the receivers;

forming a beam based on the selected calculated beam, and

transmitting data from the transmitter using the formed beam.

Herein, “multicasting” can include broadcasting, and in general refers to transmitting the same data/content to a plurality of receivers, e.g. receivers located within a defined area (such as an area/cell at least partially surrounding a transmitter) and/or within a defined timescale. The data/content may be any type of data, including, but not limited to, text, audio, image, video, instructions/code, etc.

The step of computing the number of receivers can comprise for each of the calculated beams:

determining a number of said receivers located within a sub-area of the area covered by the calculated beam according to the receiver location data, and

multiplying the determined number of said receivers located within the sub-area by a value corresponding to a receivable data transfer rate (e.g. bits per second) to generate a sum rate, and

wherein the step of selecting one of the calculated beams comprises selecting the calculated beam having a greatest said sum rate.

The receivable data transfer rate can correspond to a maximum bit/data transfer rate supported by a said receiver at an outer edge of the area/sub-area, or a bit/data transfer rate supported by a said receiver having a weakest signal reception capability within the area/sub-area. The receivable data transfer rate and/or the beam width may be related to a MODCOD scheme.

The method may include:

obtaining a receiver success value relating to a number of the receivers that successfully receive the transmitted data, and

the step of computing the number of receivers can comprise:

determining a number of said receivers located within a sub-area of the area covered by the calculated beam according to the receiver location data, and

multiplying the determined number of said receivers located within the sub-area by a value corresponding to a receivable data transfer rate and by the receiver success value to generate a sum rate, and

wherein the step of selecting one of the calculated beams comprises selecting the calculated beam having a greatest said sum rate.

The receiver success value may be based on a number of Channel Quality Indicator (CQI) signals provided by the receivers in the sub-area (or on a number of the receivers that positively acknowledge receipt of the transmitted data in some other manner). Alternatively, the receiver success value may represent an estimated probability of the receivers in the sub-area correctly receiving the transmitted data. Alternatively, the receiver success value may be based on a SNR of signals between the transmitter and the receivers in the sub-area.

The receiver location data may comprise geographical coordinate information for the plurality of receivers at a (current or prior) point in time. The receiver location data may be provided by at least some of the plurality of the receivers. In other embodiments, the receiver location data may represent an average geographical dis- tribution of the receivers within the area. In such embodiments, the method may comprise:

forming a further beam having the beam width of the selected calculated beam and having an initial angle different to the initial angle of the selected calculated beam, and

transmitting data from the transmitter using the further beam.

The steps of forming the further beam and transmitting data using the further beam may be repeated until the data has been transmitted to all of the receivers in the area/surrounding the transmitter.

The step of generating the set of calculated beams can comprise generating said a plurality of calculated beams, each said calculated beam having a said initial angle between predetermined minimum and maximum initial angles, and for each of the plurality of calculated beams, a beam width between predetermined minimum and maximum beam widths.

At least some steps of the method may be repeated for said receivers that did not receive the transmitted data. The selecting of one of the calculated beams can comprise selecting the calculated beam computed to require a minimum total time for transmitting the data to the receivers at a receivable data transfer rate over multiple iterations of the method. The method may omit said receivers that have (previously) received the transmitted data from (subsequent iterations of) at least the step of computing the number of the receivers that would receive data from each of the calculated beams using the receiver location data.

According to another aspect of the present invention there is provided apparatus (e.g. a transmitter) configured to multicast data in a wireless communications network, the apparatus comprising:

a processor configured to obtain receiver location data relating to locations of a plurality of receivers within a transmission area of the wireless communications network;

a processor configured to generate a set of calculated beams, each of the calculated beams having an initial angle and a corresponding beam width;

a processor configured to compute a number of the receivers that would receive data transmitted using each of the calculated beams using the receiver location data;

a processor configured to select one of the calculated beams based on the computed number of the receivers;

a beam former configured to form a beam based on the selected calculated beam, and

a communications interface configured to transmit data using the formed beam.

The apparatus may comprise a base station of a cellular communications network.

The wireless communications network may comprise a millimetre wavelength RF communications network. The network may comprise a network complying with a 5G standard.

According to a further aspect of the present invention there is provided a communications network comprising a plurality of apparatus substantially as described herein.

According to another aspect of the present invention there is provided a device configured to assist with multicasting data in a wireless communications network (e.g. a transmission scheduling computer in communication with at least one base station), the device comprising:

a processor configured to obtain receiver location data relating to locations of a plurality of receivers within an area covered by a transmitter of the wireless communications network;

a processor configured to generate a set of calculated beams, each of the calculated beams having an initial angle and a corresponding beam width;

a processor configured to compute a number of the receivers that would receive data transmitted using each of the calculated beams using the receiver location data, and

a processor configured to select one of the calculated beams based on the computed number of the receivers.

The device may communicate information regarding the selected calculated beam to a transmitter, e.g. a base station.

According to a further aspect of the present invention there is provided a method of assisting with multicasting data in a wireless communications network comprising:

obtaining receiver location data relating to locations of a plurality of receivers within an area covered by a transmitter of the wireless communications network;

generating a set of calculated beams, each of the calculated beams having an initial angle and a corresponding beam width;

computing a number of the receivers that would receive data transmitted using each of the calculated beams using the receiver location data, and

selecting one of the calculated beams based on the computed number of the receivers.

According to yet another aspect of the present invention there is provided a receiver configured to receive data from apparatus (or a wireless communications network) substantially as described herein.

A method of preparing multicasting of data over a wireless communications network, the method comprising:

computing characteristics of a plurality of modelled data transmission beams, and

selecting at least one said modelled data transmission beam,

wherein the step of selecting is based on a goal of minimising data transmission time to a plurality of receivers served by a transmitter (and/or maximising data reception rate on average).

According to another aspect of the present invention there is provided a computing device including, or in communication with, apparatus substantially as described herein.

According to another aspect of the present invention there is provided computer readable medium (or circuitry) storing a computer program to operate a method of multicasting data in a wireless communications network substantially as described herein.

According to the present invention, there is provided a method, an apparatus and a system as set forth in the appended claims. Other features of the invention will be apparent form the dependent claims, and the description which follows.

### Advantageous Effects of Invention

The present invention provides a method of multicasting data in a wireless communications network effectively.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 schematically illustrates an example base station and multiple receivers;

FIG. 2 is a graph illustrating example variation of SNR and bit rate with respect to beam width changes;

FIG. 3 schematically illustrates how selection of beam width affects MODCOD for data transmission to receivers;

FIG. 4 schematically illustrates the base station transmitting a beam;

FIG. 5 is a flowchart showing steps that can be involved in an embodiment of the process performed by a base station;

FIG. 6 is a graph showing a comparison between data transmitted by an example embodiment of the process and a case where very sharp beam forming angle is used;

FIG. 7 illustrates an example embodiment where averaged user distribution data is used to form a beam angle, and

FIG. 8 is a graph relating to the simulation results of the embodiment of FIG. 7.

### MODE FOR THE INVENTION

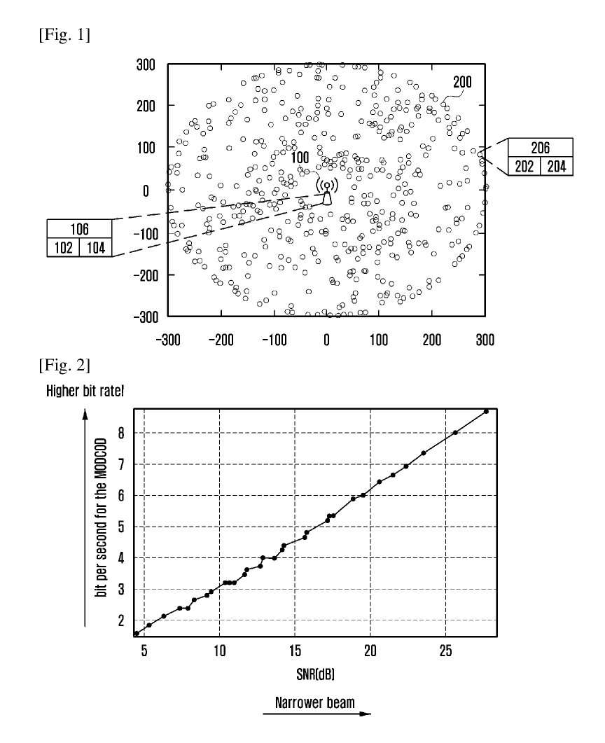

FIG. 1 illustrates a typical multicasting situation where a base station 100 is surrounded by multiple receivers 200. A wireless communications network will typically be implemented using several base stations, each of which can wirelessly transmit signals to a surrounding area (commonly called a cell in many network configurations, although the term “area” used herein should be interpreted broadly). At least part of an area served by one base station can also be served by at least one other base station. Although the example embodiments described herein are particularly applicable to millimetre wavelength RF communication or networks based on (proposed) 5G wireless network standards, it will be appreciated that alternative embodiments can operate over other types of wireless communications networks, including 3G or 4G networks, and can use various types of communications signals/protocols.

The base station 100 will normally have, or be associated with, a computing system that includes at least a processor 102, memory 104 and wireless communication unit 106, which can include components suitable for forming and transmitting a beam. It will be understood that transmitters or transceivers other than a base station could be configured to operate the methods describe herein. Each of the receivers 200 will also normally comprise, or be associated with, a computing system that includes at least a processor 202, memory 204 and wireless communication unit 206. The receivers will typically be of various different types, including transceiver devices, and examples include mobile telephones, tablet computers and other types of computing/communications devices. Other components and features of the network, base station and the receivers will be well-known to the skilled person and need not be described herein in detail.

The computing system of a base station 100 can be configured to execute a method according to the embodiments described herein in order to multicast data to receivers located in an area that at least partially surrounds it. For brevity, the operation of a single base station will be detailed below, although it will be understood that embodiments of the method can be performed by several base stations and in some cases one base station may cooperate (e.g. by sharing data) with one or more of the other base stations. It will also be appreciated that the components of the systems described herein are exemplary only and many variations are possible. For instance, any particular function/step may be performed by a single (local or remote) processor/circuit, or may be distributed over several. In alternative embodiments, a computing system, such as a transmission scheduler, remote from the base station(s) may perform beam-related computations and relay the results to the base station(s) for use in beam forming and data transmission. It will also be understood that embodiments of the methods described herein can be implemented using any suitable programming language/means and/or data structures.

In multicasting, the ideal scenario is for data transmitted by the base station 100 to reach all the surrounding receivers 200 in a specific area (for example, inside a circular perimeter) by using an omni-directional beam transmission pattern. The use of narrow beams gives a high Pᵣ which translates into higher Signal to Noise Ratio SNR Pᵣ/N0, as given by Frii's transmission equation:

Pᵣ=Pₜ+Gₜ+Gᵣ+201o(c/4πRf)

where

Pᵣ is the receive power in free space

Pₜ is the transmit power

Gₜ and Gᵣ are the transmit and receive antenna gains, respectively

R is the distance between the transmitter and receiver

f is the carrier frequency, and

c is the speed of light.

From the above equation, it can be seen that the received power is inversely proportional to the frequency squared when an ideal isotropic radiator (Gt=1) and an ideal isotropic receiver (Gr=1) are used. However, antennas or an array of antennas with antenna gains of Gt and Gr greater than unity can be used. It is also known that the when the frequency increases (resulting in correspondingly reduced wavelengths), the antenna apertures are becoming small and hence the radiation beam width at higher frequencies get narrower. Therefore, transmit and receive antennas at higher frequencies (in the example case, millimetre waves), in fact, send and receive more energy through narrower directed beams. Narrow beams can also compensate for large path loss at millimetre wave frequencies.

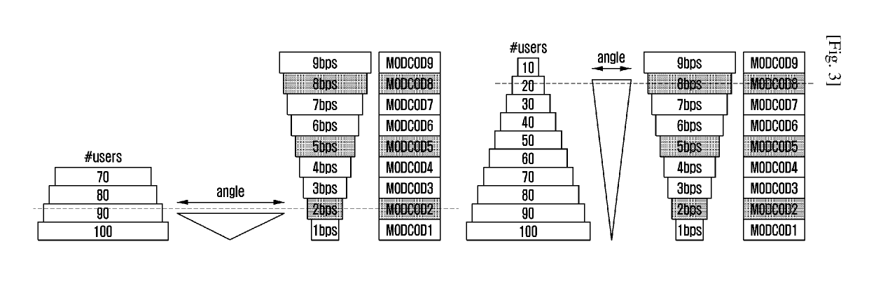

High SNR provides higher MODCOD (modulation coding pair), leading to a higher bits per second (a recent example of a system, ATSC3.0 MODCOD bps, can be found in “Millimeter Wave Mobile Communications for 5G Cellular: It Will Work!”, Rappaport, T. S.; Shu Sun; Mayzus, R; Hang Zhao; Azar, Y.; Wang, K.; Wong, G. N.; Schulz, J. K.; Samimi, M. ; Gutierrez, F). Therefore, in order to obtain higher SNR and high bit rate, narrow beam width deployment can be used. FIG. 2 is a graph illustrating example variation of SNR and bit rate with respect to beam width changes.

Omni-directional and directional beam patterns can differ in their coverage. Typically, a narrow beam width is not desired in a multi user environment because it will not be able to reach more than single (or maybe a few) receivers. In order to overcome this, it is possible to use a wide beam width transmission, which can target a greater number of receivers. In theory, this solution should work; however for multicast applications, the MODCOD also needs to be considered. As discussed above, beam width is inversely proportional to SNR and bit rate. Therefore, to obtain a higher SNR and bit rate, a narrow beam width should be used. A problem arises because the multicast system can either aim for a greater number of target receivers, which would involve sacrificing SNR and bit rate, or it can aim (by reducing the beam width) for high SNR and bit rate by reducing the target number of users. FIG. 3 schematically how the selection of beam width (corresponding to different number of receivers) affects MODCOD.

Based on considerations including the above, the present inventors devised a solution by considering the gains and compromises that can be taken in a multicast/broadcast environment:

A compromise would be to look for the best angle that will provide the highest reception rate on average, thus leading to the minimum total transmission time.

The multicast system can analyse the number of users/receivers covered by each potential beam angle and the maximum MODCOD that would allow the transmitted data signal to be received by all of them.

This can be done in an optimal way by having access to all the receivers'/users' positions and calculating the best combination of bit rate and number of receivers/users.

It can also be done in a sub-optimal way, where the base station will use information regarding the distribution of users in order to decide on the combination of beam forming/MODCOD. This suboptimal method can work better in the case of high number of receivers/users.

The calculated SNRs can be replaced by the exact CQI fed back by the receivers, if available.

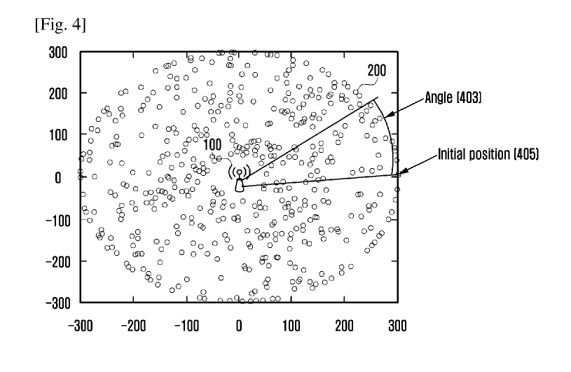

Referring to FIG. 4, it can be seen that for each angle/width 403 and initial position/angle 405 of a transmission beam, there is a MODCOD (lowest MODCOD that can be used to serve the cluster in which the receivers 200 are located with respect to the base station 100) and the number of receivers/users within the cluster covered by the beam.

At each iteration of the beam calculation/forming/transmission process, a goal is to look for the initial angle and the beam width that maximizes the criteria of minimum time to deliver the content to substantially all of the receivers. If the goal was to serve one receiver then the number of bits that can be transmitted to it is: x bps (bits per second), where the bps depends on the selected MODCOD. The selected MODCOD depends on the SNR.

The received power depends on the opening angle of the beamforming:

P=Pₜₒₜₐₗ(360/α) (1/R^{α})

where

a is the exponent of power decay (a=2 is usually used, although for millimetre wave it can be slightly less, e.g. 1.6), and

α is the beam width.

When a large beamwidth (lower MODCOD) is used, the beam can sweep across to cover a reasonability large number of the receivers at the same time. However, this has the limitation that due to a large number of users there is more probability of a Negative Acknowledgement (NACK) being received and hence retransmission may be needed one or more times. Therefore, embodiments of the process can also consider NACK as an optimization parameter. Hence, embodiments can look to a maximization goal based on:

SR=Min_{BPS}*N_{Users}*(NACK)

where

Min_{BPS} is the minimum BPS for the cluster

N_{Users} is the number of users inside the cluster, and

(NACK) is the probability of a NACK in the cluster.

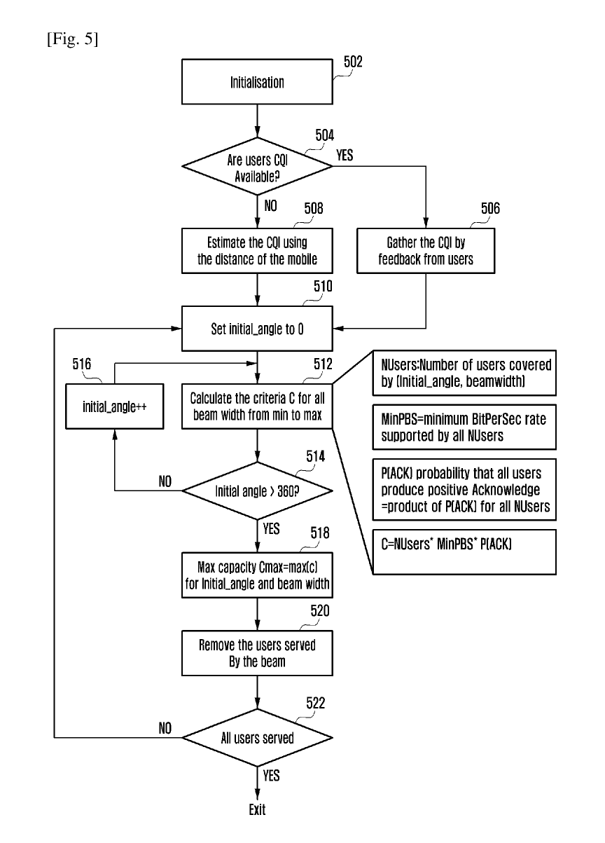

FIG. 5 is a flowchart showing steps that can be involved in an embodiment of the process, which are typically performed by a base station (and/or any other communications network component) in order to multicast data to a plurality of receivers. It will be appreciated that at least some of the steps may be re-ordered or omitted. Also, additional steps may be performed. Further, although the steps are shown as being performed in sequence in the Figure, in alternative embodiments at least some of them may be performed concurrently. The process will typically be invoked when there is a need to multicast data (e.g. based on content requests made by users of the receivers), or may be invoked periodically (e.g. by an operator of the wireless network to multicast service announcements, etc).

The process initialises at step 502. This can involve the receiving, or computing, various data, such as data regarding the locations of receivers positioned within an area at least partially surrounding the base station (e.g. at least part of the cell served by the base station), and/or a minimum bit rates useable by the receivers, and so on. This information may be received (periodically or on demand) directly from the receivers 200 and/or from some other component(s) of the communications network/system capable of providing such data. In some embodiments, this location data may be based on cellular mobile network paging information, but it can be based on other information regarding the locations of receivers and/or their users, e.g. IP addresses.

At step 504 the process asks a question as to whether CQI (or any other indicator of the quality of reception of data from the base station) is available from at least some of the receivers. If it is then at step 506 CQI data is received from (all or some of) the receivers. Alternatively, previously received CQI data may be processed. If CQI is not available then at step 508 an estimated value is calculated (for all or some of the receivers) instead, e.g. using a calculation based on the distance of the receiver from the base station.

At step 510 the process sets an initial beam angle value for its computations. In the example embodiment, this initial angle is set at 0, although it will be understood that variations are possible. At step 512 the process computes the number (C) of receivers that would, correctly/theoretically, receive data from the transmitter via a data transmission beam based on the initial angle and a corresponding beam width. This computation is typically performed for a set/range of beam widths between a minimum beam width value and a maximum beam width value. The computation can use the data regarding the locations of the receivers to determine which of the receivers are located within a sub-area of the area surrounding the transmitter that is covered by the calculated beam.

The above computations are a simple example that take into account a minimal number of factors (namely beam angle, beam width and the locations of receivers). However, in other embodiments the step 512 can involve computations based on additional factors. Examples are shown at 513A-513C, namely:

NUsers: the number of users covered by (Initial_angle, beamwidth)

MinPBS: the minimum BitPerSec rate supported by all NUsers

P(ACK): probability that all users produce positive Acknowledge=product of P(ACK) for all NUsers

In this case, the computation of step 512 can involve an equation 513D:

C=NUsers*MinPBS*P(ACK)

Typically, all the receivers will be served using the minimum bit rate (BPS) in the cluster (e.g. the bit rate of the outermost or the weakest receiver in the cluster) because otherwise some receivers will not be able to decode the data. Thus, embodiments of the process can be based on a “race to the bottom” methodology. However, an advantage is that more receivers can be served.

Data relating to the results of the computations performed at step 512 are stored for further processing. It will be understood that variations to the detailed steps disclosed above can be performed and that different data rate units, etc, may be used.

At step 514 the process checks whether the value of the initial beam angle variable is greater than 365°. If it is not then at step 516 the initial beam angle variable is incremented by one and control passes back to step 512 in order for computations based on this updated initial beam angle to be performed. Thus, in the illustrated embodiment, the process generates data representing a set of modelled/simulated transmission beams, each of the beams having characteristics including at least an initial angle (ranging incrementally from 0° to 360° in the example, although it will be understood that variations are possible), and for each of these initial angles corresponding beam widths (ranging between minimum and maximum beam width values). However, the skilled person will appreciate that variations to these steps are possible. For example, the process may not be based on incrementing the value of the initial angle and/or the beam width by one in each iteration, and instead some other calculation may be used (e.g. calculating the next initial angle and/or beam width to be used based on an estimation of which values are likely to be most useful), or using a random selection instead of incrementing by one every time.

If the question asked at step 514 is answered in the affirmative then control passes to step 518, where characteristics of a beam to be used for data transmission by the base station are selected based on the beam-related computations that have been performed by the process. Typically, the characteristics of the transmission beam are selected based on the goal of reception by the maximum number of receivers. In embodiments where the equation 513D is used at step 512 then the calculated beam initial angle and beam width resulting in the maximum value of C is used for the selection. However, different criteria may apply, e.g. beam characteristics that lead to reception of data with the lowest probability of non-acknowledgement, etc. Further, the characteristics of the calculated beam may be modified/processed in some way (e.g. having amplification, modulation, etc, applied) before use in the beam forming, i.e. the beam formed may not be an exact realisation of the simulated/calculated beam.

The wireless communications unit 106 of the base station 100 can then be controlled to form a beam based on the selected beam characteristics using any suitable beamforming technique(s). The formed beam is used to multicast data to the receivers. The process may re-transmit the data (at least once) if the data is not received by all of the receivers expected to receive it, e.g. based on the base station receiving at least one NACK. In the (usually rare) case of a NACK, the data can be retransmitted (possibly with incremental redundancy) until it is received. It the NACK receivers are few, they can be scheduled in the next cluster of receivers to be covered by the next beam transmission. The characteristics of the beam to be used for retransmission may be the same as those of the original/previous transmission attempt, or they may be recomputed (e.g. using the computations of step 512 or any other suitable computations).

At step 520 the example process may subtract the receivers that were served by the transmitted beam from a data store containing all the receivers within the area served by the base station. This may be based on information (e.g. acknowledgment signals) regarding which of the receivers actually/correctly received the data, or it may be based on an estimate (e.g. which of the receivers were computed as being covered by the beam).

At step 522 a question is asked as to whether all the receivers expected to be served have been served (e.g. whether all the receivers have acknowledged receipt of the data, or at least one attempt has been made to transmit the data to the receivers). If the answer is yes then the process can end; otherwise, control can return to step 510. The total transmission time can be calculated as the sum of the time taken to complete all iterations of the (repeated) steps of the process, with the aim of at least attempting to transmit the data to all of the receivers served by the base station.

FIG. 6 is a graph showing a comparison between data transmitted by the process of FIG. 5 and a case where very sharp beam forming angle is used. In the latter case the number of users decreases by one (or two if it happens that another user is behind the first one). The total time required to serve all users is three times the total time required by the process of FIG. 5. Therefore, the process can be considered an optimal solution for multicasting.

The main example embodiment discussed above can be modified in a way that can be considered to be sub optimal, if required (for example, in a larger system with a greater number of receivers to be served by a transmitter, such as in base station in a city location). Such embodiments do not use information from users/receivers, or data describing the locations of receivers, but, instead, use a general idea (averaged) of the geographical distribution of receivers, or information regarding receiver locations based on their previous positions that is/was not updated. A suitable transmission beam angle is then computed. The same angle can be used again (e.g. using an anticlockwise sweep or some other pattern) to serve all receivers in the area/cell. In this way the complexity of the process can be reduced. In examples of such embodiments, the criterion that is maximized can be:

Min_{BPS}*Nᵤₛₑᵣₛ*P(NACK)

where

Min_{BPS}=log 2(1+P_{d}/αN0)

P_{d} is the Power density at the cell edge (this is normally where the weakest users are located)

Nᵤₛₑᵣₛ=User_{density}* α

P(NACK)=P(NACK_{density})α

(NACK_{density}) is the probability of NACK per degree of beam angle.

The selected angle α that maximizes the criteria can then be applied for beam forming.

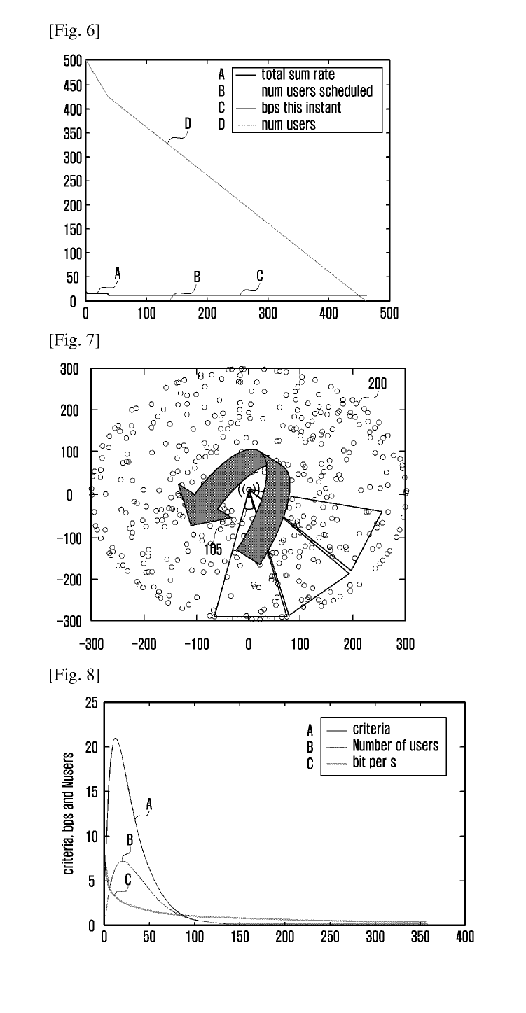

FIG. 7 illustrates an example of this “sub optimal” embodiment that uses averaged user distribution data to compute the angle of the transmission beam and then uses the same beam angle multiple times. For example, with Pd=20 dB; User density: 1 user/degree; Maximum bps=10 bps; ACK_rate=0.95. FIG. 8 is a graph showing the simulation results. It can be seen that the optimal angle that maximizes the criteria in the example is around 12°.

It is understood that according to an exemplary embodiment, a computer readable medium storing a computer program to operate a method according to the foregoing embodiments is provided.

Attention is directed to any papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of multicasting data in a wireless communications network comprising:
obtaining receiver location data relating to locations of a plurality of receivers within an area covered by a transmitter of the wireless communications network;
generating a set of calculated beams, each of the calculated beams having an initial angle and a corresponding beam width;
computing a number of the receivers that would receive data transmitted using each of the calculated beams using the receiver location data;
selecting one of the calculated beams based on the computed number of the receivers;
forming a beam based on the selected calculated beam; and
transmitting data from the transmitter using the formed beam.

2. The method according to claim 1, wherein computing the number of receivers comprises for each of the calculated beams:
determining a number of the receivers located within a sub-area of the area covered by the transmitter according to the receiver location data; and
multiplying the determined number of the receivers located within the sub-area by a value corresponding to a receivable data transfer rate (e.g. bits per second) to generate a sum rate; and
wherein selecting one of the calculated beams comprises selecting the calculated beam having a greatest sum rate.

3. The method according to claim 1, further comprising:
obtaining a receiver success value relating to a number of the receivers that may successfully receive the transmitted data,
wherein computing the number of receivers comprises:
determining a number of the receivers located within a sub-area of the area covered by the transmitter according to the receiver location data, and
multiplying the determined number of the receivers located within the sub-area by a value corresponding to a receivable data transfer rate and by the receiver success value to generate a sum rate, and
wherein one of the calculated beams comprises selecting the calculated beam having a greatest sum rate.

4. The method according to claim 2, wherein the receivable data transfer rate corresponds to one of a maximum bit/data transfer rate supported by a receiver at an outer edge of the sub-area, and a bit/data transfer rate supported by a receiver within the sub-area having a weakest signal reception capability.

5. The method according to claim 3, wherein the receiver success value is based on a number of Channel Quality Indicator (CQI) signals provided by the receivers in the sub-area.

6. The method according to claim 3, wherein the receiver success value represents an estimated probability of the receivers in the sub-area correctly receiving the transmitted data.

7. The method according to claim 1, wherein the receiver location data comprises geographical coordinate information for the plurality of receivers at one of a current point in time and a prior point in time.

8. The method according to claim 1, wherein the receiver location data represents an average geographical distribution of the receivers within the area, and the method further comprises:
forming a further beam having the beam width of the selected calculated beam and having an initial angle different from the initial angle of the selected calculated beam; and transmitting data from the transmitter using the further beam.

9. The method according to claim 8, wherein forming the further beam and transmitting data using the further beam are repeated until the data has been transmitted to all of the receivers in the area.

10. The method according to claim 1, wherein at least some steps of the method are repeated for the receivers that did not receive the transmitted data, and wherein the method omits the receivers that have received the transmitted data from subsequent iterations of at least the step of computing the number of the receivers that receive data from each of the calculated beams using the receiver location data.

11. An apparatus configured to multicast data in a wireless communications network, the apparatus comprising:
a processor configured to:
obtain receiver location data relating to locations of a plurality of receivers within a transmission area of the wireless communications network,
generate a set of calculated beams, each of the calculated beams having an initial angle and a corresponding beam width,
compute a number of the receivers that would receive data transmitted using each of the calculated beams using the receiver location data, and
select one of the calculated beams based on the computed number of the receivers;
a beam former configured to form a beam based on the selected calculated beam; and
a communications interface configured to transmit data using the formed beam.

12. The apparatus according to claim 11, wherein the apparatus comprises a base station of a cellular communications network.

13. The apparatus according claim 11, wherein the wireless communications network comprises a millimeter wavelength RF communications network.

14. A communications network comprising a plurality of apparatuses according to claim 11.

15. A computer readable medium storing a computer program to operate a method according to claim 1.

16. A method according to claim 3, wherein the receivable data transfer rate corresponds to one of a maximum bit/data transfer rate supported by a receiver at an outer edge of the sub-area, and a bit/data transfer rate supported by a receiver within the sub-area having a weakest signal reception capability.

17. The apparatus according claim 12, wherein the wireless communications network comprises a millimeter wavelength RF communications network.
